(19) United States
(12) Patent Application Publication
(10) Pub. No.: US 2010/0207866 A1
(43) Pub. Date: Aug. 19, 2010

(54) BACKLIGHT MODULE, LIQUID CRYSTAL BACKLIGHT UNIT AND TELEVISION SET

(75) Inventor: Hiroshi Kunii, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/680,907

(22) PCT Filed: Aug. 19, 2008
(86) PCT No.: PCT/JP2008/064742

§ 371 Date: Mar. 31, 2010

(30) Foreign Application Priority Data
Dec. 21, 2007 (JP) 2007-330927

(51) Int. Cl. G09G 3/36

(52) U.S. Cl. 345/102

(57) ABSTRACT

In an arrangement area of lamps (16) in the backlight chassis (14), a main longitudinal direction of the lamps (16) lies in a first direction and the lamps (16) are arranged at uneven intervals (P), and the area has a high-density area (center area (Rc)) in which the lamps (16) are arranged with high density and a low-density area (upper area (Rt) and lower area (Rb)) in which the lamps (16) are arranged with low density. The backlight chassis (14) has a heat releasing member arranged on its backside in the high-density area.

### TECHNICAL FIELD

The present invention relates to a backlight module, a liquid crystal backlight unit, a liquid crystal display device and a television set, each of which can attain both a good black state and a good white state.

Specifically, the present invention relates to a backlight module or the like which can realize a bright white state while also realizing a dark black state with few excess brightness.

### BACKGROUND ART

Conventionally, a backlight module has been broadly used as a light source for a liquid crystal display device.

A structure of the backlight module is schematically described with reference to FIG. 14, which is a cross-sectional view schematically showing the structure of the conventional backlight module.

As illustrated in FIG. 14, the conventional backlight module 10 includes, as its main constituents, a backlight chassis 14 which has substantially a same size as a liquid crystal panel 60 that is combined with the backlight module 10, lamps 16 attached to the backlight chassis 14, a diffusing plate 20 for diffusing light from the lamps 16, and the like.

Further, the lamps 16 are generally arranged in the backlight module 10 at substantially even intervals, as illustrated in FIG. 14.

Here, the lamps 16 arranged in the backlight module increases in number as the liquid crystal panel 60 increases in size.

Temperature Rise

When the backlight module 10 includes a plurality of the lamps 16 as described above, especially when the backlight module 10 includes a large number of lamps 16, the lamps 16 release a great amount of heat, thereby causing the backlight module 10 to reach a high temperature.

Furthermore, the backlight module 10 which reaches a high temperature causes the liquid crystal panel 60 combined with the backlight module 10 to reach a high temperature, thereby causing problems such as a change in display characteristic of the panel and deterioration in display quality of the panel.

(Patent Literature 1)

Hence, various techniques are proposed in order to prevent the backlight module from rising in temperature.

For example, Patent Literature 1 discloses a technique in which a metal plate is attached to an entire backside of a reflecting plate (backlight chassis) of a backlight in a backlight module, via an elastic body.

With the technique, heat within the backlight module is conducted to the metal plate via the elastic body, and the heat within the backlight module is released from the metal plate.

Patent Literature 1

Japanese Patent Application Publication, Tokukai, No. 2005-37823 A (Publication Date: Feb. 10, 2005)

### SUMMARY OF INVENTION

However, the conventional backlight module has a problem that heat releasing property is not sufficient, as described below.

Recently, a liquid crystal panel 60 incorporated in a backlight module 10 has further increased in size, and the requisite number of lamps 16 has increased together with this increase. In addition, the liquid crystal panel 60 requires further high quality display.

In order to fulfill such a request, a backlight module 10 in which a way of arranging the lamps 16 is modified, has been proposed. The following description explains such a modified arrangement with reference to FIG. 13, which is a cross-sectional view schematically illustrating a structure of the backlight module 10.

As illustrated in FIG. 13, in the backlight module 10, a density of the lamps 16 arranged in a backlight chassis 14 is different between end parts of a screen and a center part of a screen. Concretely, the density of the lamps 16 is higher around the center part of the screen than that around the end parts of the screen.

In other words, a pitch between the lamps 16 is narrower around the center part of the screen than that around the end parts of the screen.

The density differs as such to enhance brightness around the center part of the screen of the liquid crystal panel 60 where viewers mainly tend to watch, thereby allowing clear display of an image to the viewers.

In-Plane Temperature Unevenness

However, such a backlight module 10 tends to have an uneven in-plane temperature. For example, the temperature in the center part of the screen tends to be higher than that of the end parts of the screen.

Therefore, with this backlight module 10, even if the screen is cooled evenly, it is still difficult to reduce the in-plane temperature unevenness of the backlight module 10.

Black Display

Further, the in-plane temperature unevenness of the backlight module 10 causes degrading of black display quality, as described below.

Generally, brightness of a lamp is dependent on temperature. When the temperature of the lamp rises, luminous efficiency increases and thus the brightness increases.

Therefore, with the backlight module 10 in which a plurality of lamps 16 are arranged, when the lamps 16 with different temperatures coexist, even if the lamps 16 are lighted under a single condition, difference in brightness generates within one plane.

This difference in in-plane brightness particularly causes a problem in black display.

That is, in a case of displaying black in the center part of the screen, the temperature in that part is high because the density of the lamps 16 is high. Due to the high temperature, the brightness of the lamps 16 becomes high, and as a result, the black color does not sink down, and so-called excess brightness occurs.

Further, black display on an entire screen causes even further degrading of display quality. That is, the end parts of the screen have a relatively low temperature since the density of the lamps 16 is low, which low temperature causes the lamps 16 to have a relatively low brightness. However, the lamps 16 in the center part of the screen have an increased brightness, as described above.

As a result, when the black display is performed on the entire screen, the black is uneven within the screen, and a darker black color is displayed in the end parts, whereas a whitish black color is displayed in the center part.

Consequently, the present invention is made in view of the foregoing problem, and an object of the present invention is to achieve a backlight module, a liquid crystal backlight unit and a television set, each of which has few in-plane brightness unevenness and which can attain both a good white state and a good black state.

Concretely, an object of the present invention is to provide a backlight module, a liquid crystal backlight module and a television set, each of which can attain not only a bright white display but also a darker black display with few excess brightness, while preventing generation of in-plane unevenness.

In order to solve the problems, a backlight module of the present invention comprises a backlight chassis and a plurality of light sources arranged in the backlight chassis. In an arrangement area of the light sources in the backlight chassis, the light sources are arranged in an area of the backlight chassis in which the light sources are to be positioned, so that a main longitudinal direction of the light sources lies in a first direction and the light sources are arranged at uneven intervals, and the area has a high-density area in which the light sources are arranged with high density and a low-density area in which the light sources are arranged with low density. The backlight chassis has a heat releasing member arranged on its backside in the high-density area.

According to the structure, the arrangement area of the light sources has an area where the arrangement density of the light sources is high and an area where the arrangement density of the light sources is low. Therefore, it is possible to brighten a desired area in accordance with a using condition of the backlight module, particularly a position of a viewer of a display panel provided in the backlight module. This, as a result, allows the viewer to see a bright display, especially, a bright white display.

Further, with the structure, it is possible to prevent generation of in-plane brightness unevenness, as described below.

Generally, a light source generates heat upon lighting. Moreover, a light emitting characteristic of the light source changes based on a temperature of the light source itself and a temperature around the light source. Concretely, for example, when the light source of a high temperature and the light source of a low temperature are lighted under the same condition, brightness is higher in the light source of the high temperature than that of the light source of the low temperature.

Consequently, in a case where the area in which the light sources are arranged has the high-density area and the low-density area as in the foregoing structure, the temperatures of the light sources differs between the high-density area and the low-density area. This is because the high-density area has more heat generating sources, thereby causing easy temperature rise in such an area, which together causes increase in the temperature of the light sources in that area.

However, in the low-density area, the temperature of the light sources may relatively decrease, due to the same reason as the above.

Consequently, when the light sources of the entire backlight module are lighted under the same condition, a light emitting luminance of the light sources differs between the high-density area and the low-density area.

Further, coexistence of the light sources with different light emitting luminance in the backlight module causes in-plane brightness unevenness.

Particularly, when a black color is displayed on a display panel included in the backlight module, display in a whitish black color, so-called, excess brightness occurs in a part having the light sources having a high light emitting luminance.

On the contrary, with the backlight module of the foregoing structure, a heat releasing member is arranged in a part corresponding to the high-density area where the temperature rises easily.

This prevents the temperature rise in the high-density area, and reduces a temperature difference between the high-density area and the low-density area. As a result, a difference in light emitting luminance of the light sources between the high-density area and the low-density area is reduced, thereby reducing the in-plane brightness unevenness.

Particularly, in the case of displaying the black color, the temperature rise of the light sources in the high-density area is suppressed, thereby the rise in the light emitting luminance of the light sources is also suppressed. Consequently, it is possible to prevent the foregoing excess brightness, thereby allowing a blackish black display.

From the above, the backlight module has less in-plane brightness unevenness, and can have both a good white state and a good black state.

Concretely, the backlight module can achieve both a black display with few excess brightness and a bright white display, while suppressing occurrence of in-plane unevenness.

Moreover, it is preferable to arrange the backlight module of the present invention such that the high-density area is provided at a middle part in a direction intersecting with the first direction of the area in which the light sources are arranged.

With the structure, the high-density area is provided in the center part in the area in which the light sources are arranged, eventually, in the center part of the backlight module. Therefore, for example, it is easier to attain a brighter display, for example, for a viewer of the display panel that incorporates the backlight module.

Further, it is preferable to arrange the backlight module of the present invention such that the heat releasing member is made of at least one of copper, silicone, aluminum and ceramics.

With the structure, since the heat releasing member is made of a material having a high thermal conductivity, it is possible to release heat more efficiently.

Moreover, in the backlight module of the present invention, the backside of the backlight chassis of the high-density area is made in a waved form.

With the structure, since the backside of the backlight chassis is provided as a waved form, a surface area of the backlight chassis is broadened. Therefore, it is possible to release heat more efficiently.

Further, in a case where not only the backside but also a front side (inner side) of a bottom side (bottom part) of the backlight chassis is made in a waved form, it is possible to reduce a thickness of the backlight module more easily.

Furthermore, in the backlight module of the present invention, the intervals between the light sources in the high-density area match intervals of the waves.

This structure makes it possible to easily attain fixed distances from the light sources to the backlight chassis.

Consequently, upon flow of electric current of the light sources into the backlight chassis, decrease in lighting properties of the light sources and increase in luminance unevenness are easily prevented.

Further, in the backlight module of the present invention, the heat releasing member is provided as a sheet-form, and is attached to the backside of the backlight chassis with an adhesive agent, to arrange the heat releasing member on the backside of the backlight chassis.

With the structure, the heat releasing member is arranged to the backlight chassis by being attached to the backlight chassis. Hence, the backlight module is produced in an easy manner.

In addition, since the heat releasing member is of a sheet form, increase in thickness of the backlight module is easily avoidable. Additionally, despite the backlight chassis having an uneven backside, for example, even if the backside of the backlight chassis is made in a waved form, the heat releasing member may be easily adhered closely to the backside of the backlight chassis.

Further, it is preferable to arrange a liquid crystal backlight unit of the present invention such that a liquid crystal backlight unit comprises a liquid crystal panel incorporated in the backlight module, and the first direction is a horizontal direction when seen from viewers of the liquid crystal panel.

With the structure, a main longitudinal direction of the light sources is arranged to be in a horizontal direction seen from the viewers of the liquid crystal panel. Therefore, it is possible for the viewers to easily see a display which has few in-plane brightness unevenness in a broad area, particularly, in the left and right lateral direction (horizontal direction) of the liquid crystal panel.

Moreover, it is preferable to arrange the liquid crystal backlight unit of the present invention such that a circuit board for controlling the light sources or the liquid crystal panel is arranged on the backside of the backlight chassis in an area other than an area upper of the heat releasing member.

Generally, in one chassis (substrate), the heat releasing member is unlikely to release heat generated from a heat source which is arranged in a position upper than that of the heat releasing member than heat generated from a heat source which is arranged in a position lower than that of the heat releasing member.

However, with the structure, a circuit board, which is generally a heat source, is arranged in an area other than an area upper of the heat releasing member, on the backside of the backlight chassis. Thus, the heat generated from the circuit board is released more effectively.

Note that upper and lower respectively indicate upper and lower directions with respect to a horizontal surface including the horizontal direction.

Further, it is preferable to arrange the liquid crystal backlight unit of the present invention such that the circuit board is arranged on the backside of the backlight chassis just in an area lower of the heat releasing member.

With the structure, the circuit board is arranged only in the area lower than that of the heat releasing member, in which area heat generated by the circuit board is more easily released by the heat releasing member. Accordingly, it is possible to release the heat generated by the circuit board more effectively.

Moreover, it is preferable that a television set of the present invention comprises the liquid crystal backlight unit.

With the structure, the television set includes the liquid crystal backlight unit which has few in-plane brightness unevenness and can attain both a good white state and a good black state. This allows the television set to perform high-definition display.

In a backlight module of the present invention, as described above, in an arrangement area of the light sources in the backlight chassis, the light sources are arranged in an area of the backlight chassis in which the light sources are to be positioned, so that a main longitudinal direction of the light sources lies in a first direction and the light sources are arranged at uneven intervals, and the area has a high-density area in which the light sources are arranged with high density and a low-density area in which the light sources are arranged with low density. The backlight chassis has a heat releasing member arranged on its backside in the high-density area.

Therefore, this provides a backlight module which has few in-plane brightness unevenness and attains both a good white state and a good black state.

### BRIEF DESCRIPTION OF DRAWINGS

FIG. 1 shows an embodiment of the present invention, and is a plan view of a backlight module.

FIG. 2 shows an embodiment of the present invention, and is a plan view of a backside of a liquid crystal backlight unit.

FIG. 3 shows an embodiment of the present invention, and is a cross-sectional view taken along line A-A of FIG. 2.

FIG. 4 shows an embodiment of the present invention, and is a cross-sectional view taken along line B-B of FIG. 2.

FIG. 5 shows another embodiment of the present invention, and is a view corresponding to a cross-section taken along line A-A of FIG. 2.

FIG. 6 shows an embodiment of the present invention, and is a cross-sectional view of a backlight module.

FIG. 7 shows another embodiment of the present invention, and is a view corresponding to a cross-section taken along line A-A of FIG. 2.

FIG. 8 shows another embodiment of the present invention, and is a plan view of a backside of a liquid crystal backlight unit.

FIG. 9 shows another embodiment of the present invention, and is a cross-sectional view taken along line C-C of FIG. 8.

FIG. 10 shows another embodiment of the present invention, and is a plan view of a backside of a liquid crystal backlight unit.

FIG. 11 shows another embodiment of the present invention, and is a plan view of a backside of a liquid crystal backlight unit.

FIG. 12 is a perspective view schematically showing a structure of a television set of the present invention.

FIG. 13 is a sectional view schematically showing a structure of a backlight module.

FIG. 14 is a sectional view schematically showing a structure of a conventional backlight module.

### REFERENCE SIGNS LIST

10 Backlight module
14 Backlight chassis
16 Lamp (light source)
30 Inverter substrate (circuit board)
40 Heat releasing member
70 Seat (support)
50 Liquid crystal backlight unit
60 Liquid crystal panel
62 Main substrate (circuit board)
64 Power supply substrate (circuit board)
66 Composite substrate (circuit board)
80 Television set
P Gap
Rt Upper area (low-density area)
Rc Center area (high-density area)
Rb Lower area (low-density area)

### DESCRIPTION OF EMBODIMENTS

### Embodiment 1

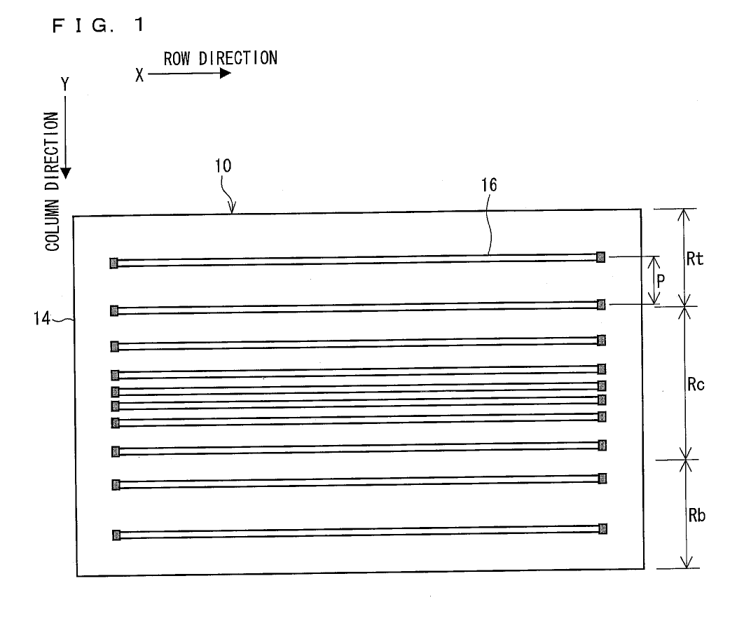

The following description explains an embodiment of the present invention with reference to FIG. 1 and the like.

FIG. 1 is a plan view schematically showing a structure of a backlight module 10 of the present embodiment.

Backlight Module

The backlight module 10 of the present embodiment, as shown in FIG. 1, includes a substantially rectangular backlight chassis 14 that has a substantially identical shape and size with a liquid crystal panel (not shown) incorporated in the backlight module 10, and straight tubular lamps 16 disposed in the backlight chassis 14. In addition, the backlight module 10 includes an inverter substrate (not shown) for lighting the lamps 16. The inverter substrate is described later.

In the present embodiment, a material of the backlight chassis 14 is not particularly limited, however the backlight chassis 14 is preferably made of a metal material such as iron, stainless steel or aluminum, a resin material, or like material.

The lamps 16 are not limited to the straight tubular lamps, and lamps of various shapes are usable. Furthermore, types of the lamps 16 are not particularly limited, and examples thereof include a cold cathode tube (CCFL: Cold Cathode Fluorescent Lamp) and a hot cathode tube (HCFL: Hot Cathode Fluorescent Lamp). Moreover, an electroluminescence (EL) lamp may also be used.

Position of Lamps

The following describes how the lamps 16 are positioned in the backlight module 10 of the present embodiment.

As shown in FIG. 1, the straight tubular lamps 16 are positioned in the backlight module 10 of the present embodiment in such a manner that its extending direction is substantially parallel to a longitudinal direction (row direction X shown in FIG. 1) of the rectangular backlight chassis 14.

Further, a density of the lamps 16 is higher in a center area Rc than in an upper area Rt and a lower area Rb, wherein the backlight module 10 is divided into three areas from the top in a shorter direction (column direction Y shown in FIG. 1) of the backlight chassis 14: the upper area Rt; the center area Rc; and the lower area Rb.

In other words, gaps (pitch) P between adjacent lamps 16 narrows as the lamps come closer to the center of the backlight chassis 14 from upper and lower end parts of the backlight chassis 14.

Liquid Crystal Backlight Unit

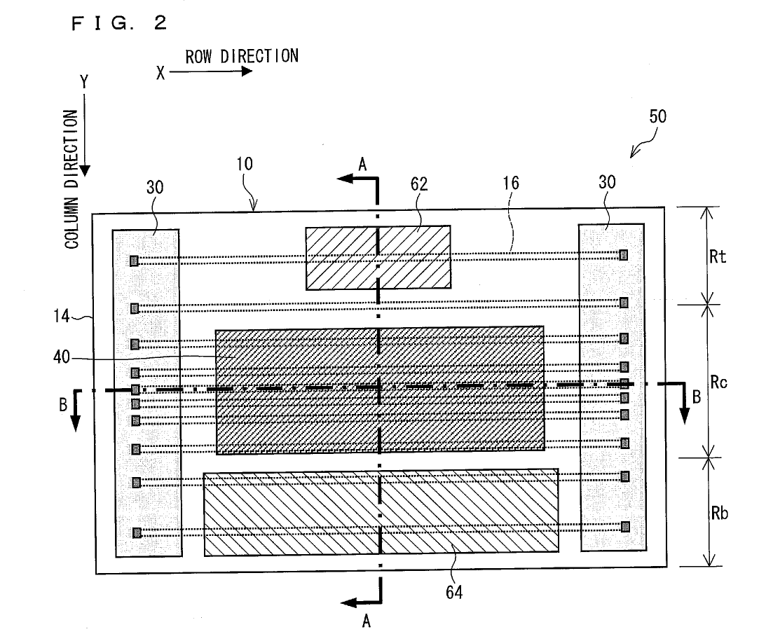

The following describes a liquid crystal backlight unit 50 of the present embodiment with reference to FIG. 2. FIG. 2 is a plan view of a backside of the liquid crystal backlight unit 50 of the present embodiment.

The liquid crystal backlight unit 50 of the present embodiment has a substantially identical structure with the liquid crystal backlight unit 50 already described with reference to FIG. 14. That is, the liquid crystal backlight unit 50 of the present embodiment has a liquid crystal panel (not shown) incorporated in the backlight module 10.

Further, the liquid crystal backlight unit 50 of the present embodiment, as shown in FIG. 2, has inverter substrates 30 provided on a backside of the backlight chassis 14, for lighting the lamps 16.

Specifically, the inverter substrates 30 are rectangular, and a length in its longitudinal direction is substantially the same as a length of the backlight chassis 14 in its shorter direction.

Furthermore, the inverter substrates 30, two in total, are positioned respectively along end parts of the shorter direction of the backlight chassis 14.

Heat Generating Substrate

The following describes a heat generating substrate included in the liquid crystal backlight unit 50 of the present embodiment.

Various substrates are usable as the heat generating substrate, including the inverter substrates 30 already described. In the present embodiment, a main substrate 62 and a power supply substrate 64 are described as typical examples.

In the present embodiment, both the main substrate 62 and the power supply substrate 64 are of a rectangular shape.

The main substrate 62 is positioned along an upper part of the backlight chassis 14, which main substrate 62 has its longitudinal direction substantially parallel to the row direction X. That is, the main substrate 62 of the present embodiment is positioned in the upper area Rt already described.

On the other hand, the power supply substrate 64 is positioned along a lower part of the backlight chassis 14, with its longitudinal direction substantially parallel to the row direction X, similarly to the main substrate 62. That is, the power supply substrate 64 of the present embodiment is positioned in the lower area Rb already described.

Heat Releasing Member

The following describes a heat releasing member 40 of the present embodiment. As shown in FIG. 2, in the present embodiment, the heat releasing member 40 is substantially rectangular, and is provided in a center area Rc of the backlight chassis 14.

Specifically, the heat releasing member 40 has its longitudinal direction substantially parallel to the row direction X, and is positioned in the center area Rc where the lamps 16 are closely spaced. In other words, the heat releasing member 40 is positioned in an area which is surrounded on all four sides respectively by the two inverter substrates 30, the main substrate 62 and the power supply substrate 64, each of which is already described.

That is to say, the heat releasing member 40 of the present embodiment is disposed in an area that has the lamps 16 closely spaced, thereby generating a great amount of heat that easily causes a rise in temperature.

Sectional Structure 1

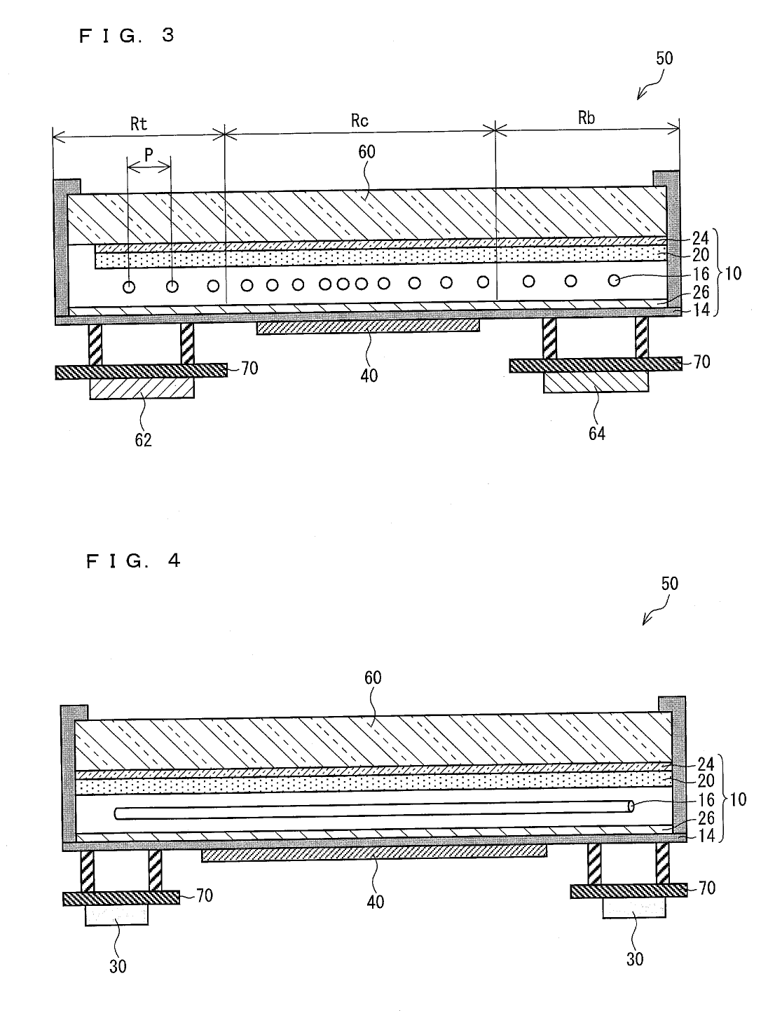

The following describes a sectional structure of a backlight module 10 of the present embodiment with reference to FIG. 3 and FIG. 4. Here, FIG. 3 is a cross-sectional view taken along line A-A of FIG. 2, and FIG. 4 is a cross-sectional view taken along line B-B of FIG. 2.

Front side (Inner side) of Backlight Chassis

As shown in FIG. 3, in the backlight module 10 of the present embodiment, the backlight chassis 14 is shaped like a tray seen from a sectional view, and a reflecting sheet 26 is provided substantially over an entire inner side of a bottom of the backlight chassis 14.

Here, the reflecting sheet 26 is not particularly limited as long as it is a member which reflects light, and for example, a material in which a metal is deposited on a resin film may be used.

Further, the straight tubular lamps 16 are positioned above the reflecting sheet 26, that is, on an emitting side of the backlight module 10. Here, as described above, the upper area Rt and the lower area Rb of the backlight module 10 have broad gaps P between adjacent lamps 16 disposed therein, and the center area Rc of the backlight module 10 has narrow gaps P between adjacent lamps 16 disposed therein. Furthermore, the gaps P become gradually narrow in a symmetrical manner as the lamps 16 are disposed closer to the center part of the backlight module 10, thereby resulting to have a narrowest width in the center.

Above the lamps 16, a diffusing plate 20 for evenly diffusing lights from the lamps 16 over a screen and a lens sheet 24 for emitting lights to a desired direction are provided.

Further, a liquid crystal panel 60 is provided on a front side (emitting side) of the backlight module 10. This schematically achieves a liquid crystal backlight unit 50.

Backside (Outside) of Backlight Chassis

The following describes a backside of the backlight chassis 14.

A bottom side of the backlight chassis 14, as described above, has the main substrate 62, the power supply substrate 64 and the heat releasing member 40.

In detail, the main substrate 62 is provided on the upper area Rt of the backlight module 10, via a seat 70. The seat 70 in the present embodiment is of a bridge girder form. Further, by mounting the main substrate 62 on the backlight chassis 14 via the seat 70, a space is formed between the backlight chassis 14 and the main substrate 62.

Further, the power supply substrate 64 is also positioned in the lower area Rb of the backlight module 10 via the seat 70, as with the main substrate 62.

Both the power supply substrate 64 and the main substrate 62 are provided to the backlight chassis 14 via the seats 70 in the bridge girder form. Therefore, heat generated from the substrates is unlikely to be conducted to the backlight chassis 14.

In addition, space (atmospheric layer) exists between the substrates and the backlight chassis 14, thus the heat generated from the substrates is likely to be released.

That is, the seat 70 is unlikely to conduct the heat generated from the substrates to the backlight chassis 14 and is also likely to release the heat. Namely, the seat 70 functions as a heat releasing plate.

Seat

Here, a member constructing the seat 70 is not particularly limited, and suitably used examples thereof include copper, aluminum and ceramics, which are materials that have excellent heat releasing properties.

Further, for example, a thickness of a flat part of the seat 70 may range from 0.1 mm to 1.0 mm. Furthermore, a size of the flat part is arbitrarily determined in accordance with a size of a mounted substrate (a heat generating substrate such as the main substrate 62, the power supply substrate 64, or the inverter substrate 30). For example, as the size of the flat part, a longitudinal dimension may range from 10 mm to 500 mm and a lateral dimension may range from 10 mm to 400 mm.

Heat Releasing Member

Further, the heat releasing member 40 is directly provided on the backside of the backlight chassis 14 in an area corresponding to the center area Rc of the backlight module 10.

Here, a material and structure of the heat releasing member 40 is not particularly limited as long as it is a member having excellent heat releasing properties.

For example, the material having heat releasing properties (heat releasing material) may be attached to the backlight chassis 14 via an adhesive layer such as an adhesive or glue.

In this case, examples of the heat releasing material include copper, silicone and ceramics.

Furthermore, in case of using the heat releasing material in a sheet form (heat releasing sheet), a size of the heat releasing sheet is not particularly limited, and is determined as appropriate in accordance with a size of the center area Rc of the backlight module 10. For example, a thickness of the heat releasing sheet ranges from 0.1 mm to 1.0 mm, a longitudinal dimension of the heat releasing sheet ranges from 10 mm to 500 mm, and a lateral dimension of the heat releasing sheet ranges from 10 mm to 400 mm.

Moreover, the heat releasing material, especially, a material (adhesive agent) for attaching and fixing the heat releasing sheet to the backlight chassis 14, is not particularly limited. Examples thereof include acrylic-, polyester- and synthetic-resin adhesives.

Sectional Structure 2

The following describes a structure of a liquid crystal backlight unit 50 of the present embodiment with reference to a cross-sectional view taken from a direction different from FIG. 3, namely, with reference to FIG. 4 which is a cross-sectional view taken along line B-B of FIG. 2.

As shown in FIG. 4, the inverter substrates 30 arranged in the liquid crystal backlight unit 50 of the present embodiment are arranged to the backlight chassis 14 via the seats 70, as with the main substrate 62 and the power supply substrate 64 already described with reference to FIG. 3.

Here, the same seats as the seats 70 described regarding the main substrate 62 and the power supply substrate 64 are used for the seats 70 used for fixing the inverter substrates 30.

This makes it difficult for heat generated from the inverter substrates 30 which are a type of heat generating substrates to be conducted to the backlight chassis 14, thereby making it easy to release heat.

### Embodiment 2

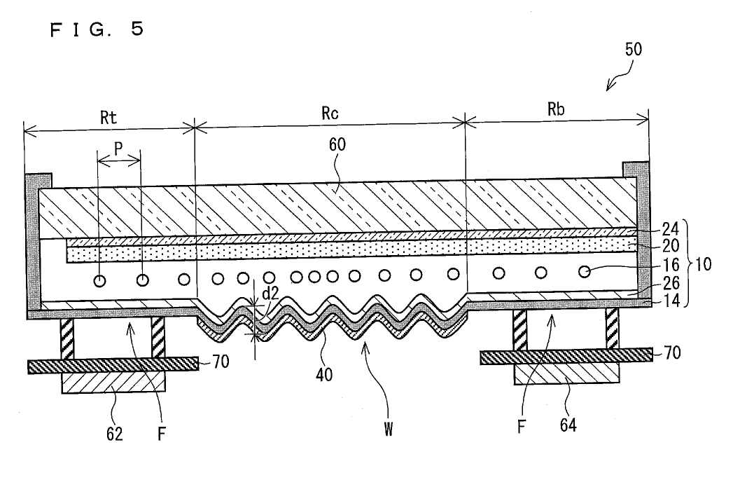

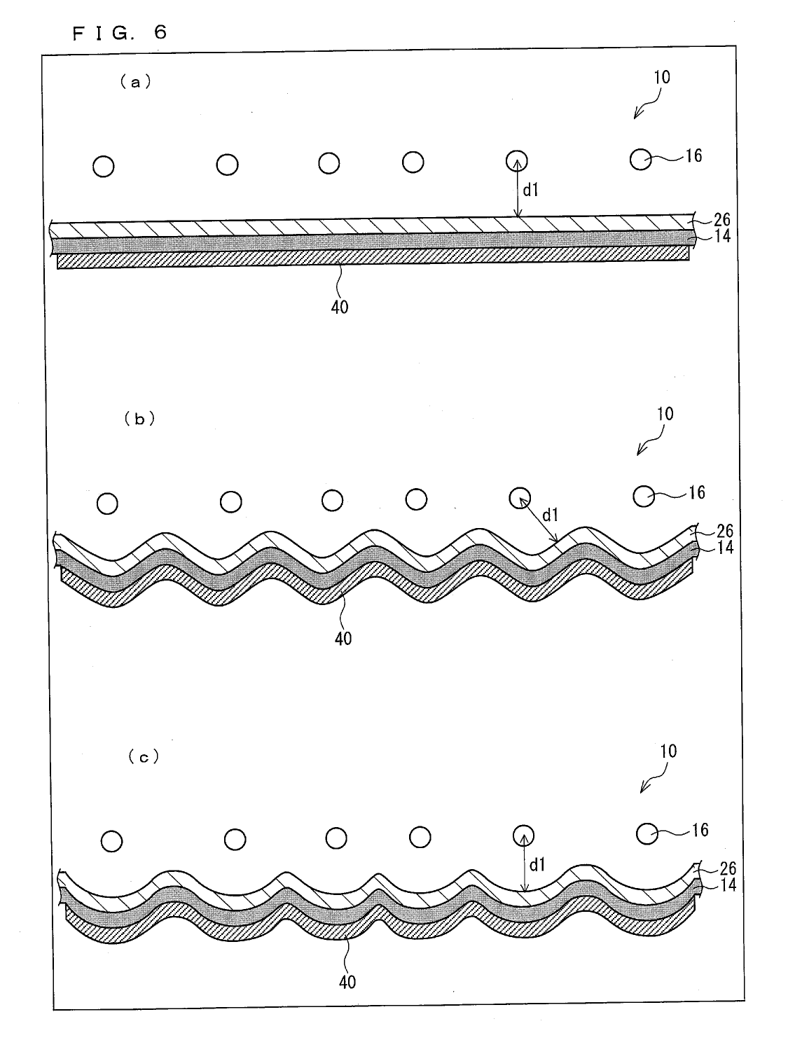

The following describes another embodiment of the present invention with reference to FIG. 5 and FIG. 6. Note that structures other than what is described in the present embodiment are identical to that of Embodiment 1. Further, for convenience in description, identical reference signs are provided to members having identical functions with the members indicated in the drawings describing Embodiment 1, and descriptions of the members are omitted here.

A backlight module 10 of the present embodiment is different from the backlight module 10 of Embodiment 1 in that a shape of a bottom of the backlight chassis 14 is not plane-shaped (flat) but waved. Accordingly, a shape of a backside of a backlight chassis 14 is also waved. The following describes the backlight module 10 with respect to FIG. 5 which is a view showing a cross-section of the backlight module 10 of Embodiment 2. Note that FIG. 5 is a view corresponding to a cross-section taken along line A-A of FIG. 2.

As shown in FIG. 5, the backlight module 10 of the present embodiment has a bottom of the backlight chassis 14 made in a wave form (ripple) with a fixed interval and height, in the center area Rc of the backlight module 10 (section W in FIG. 5). However, in the upper area Rt and the lower area Rb, the bottom of the backlight chassis 14 is flat, as with the backlight chassis 14 of Embodiment 1 (section F in FIG. 5).

Here, a height of the wave (d2) is not particularly limited, and for example, may range from 5 mm to 20 mm. Further, a whole width of an area where the wave W is formed is not particularly limited, however may be a width of the center area Rc, for example, from 10 mm to 500 mm.

In addition, by making the bottom of the backlight chassis 14 waved as described above, a surface area of the backlight chassis 14 in its corresponding area is made larger.

Accordingly, heat releasing properties in this area is improved. Therefore, formation of the waved shape in an area where lamps 16 are closely spaced, that is, an area where gaps P are narrow, is capable of easily decreasing a difference in temperature between the area where the lamps 16 are closely spaced and other areas where the lamps 16 are not closely spaced.

Further, as the backlight chassis 14 of the present embodiment, in a case where a part to which a heat releasing member 40 is attached is not flat, thereby making the heat releasing material which is an example of the heat releasing member 40 in a sheet form (heat releasing sheet), the heat releasing material is easily attachable to a backside of the backlight chassis 14 having no gap therebetween. As a result, the heat releasing member 40 enhances a heat releasing effect.

Shape of Bottom

The following further describes a shape of a bottom of the backlight chassis 14 with respect to (a) and (b) of FIG. 6.

In FIG. 6, (a) and (b) are cross-sectional views of the center area Rc of the backlight modules 10. Further, (a) of FIG. 6 shows the backlight module 10 of Embodiment 1, (b) of FIG. 6 shows the backlight module 10 of the present embodiment (Embodiment 2), and (c) of FIG. 6 shows another example of the present embodiment.

As shown in (a) of FIG. 6, the bottom of the backlight chassis 14 is plane-shaped (flat) in Embodiment 1.

However, as shown in (b) of FIG. 6, a bottom of the backlight chassis 14 is waved (in a wave form) having a fixed interval and height, in the present embodiment.

In the present embodiment, a waved shape of the bottom of the backlight chassis 14, which shape is a feature of the present embodiment, is not limited to the specific interval and height, and for example, the shape may match the pitches of the lamps 16.

That is to say, as described above, in the backlight module 10 of the present embodiment, gaps P between the lamps 16 are uneven, and the gaps are made gradually narrower as the lamps are disposed closer to the center part from end parts of the backlight module 10.

Therefore, the waved shape of the bottom of the backlight chassis 14 may be changed from the waved shape having a fixed interval and height to a shape corresponding to the intervals of the lamps 16. Specifically, gaps P between waves may be made narrower in connection with the change in the gaps P between the lamps 16, from the end parts to the center part.

With such a structure, it is easy to make a shortest distance d1 from the lamps 16 to the backlight chassis 14 in substantially even intervals regardless of the lamps 16.

This prevents deterioration of lighting properties of the lamps 16 and occurrence of luminance unevenness, each of which is caused by a flow of electric current of the lamps 16 into a steel plate of the backlight chassis 14 (occurrence of leakage electric current).

### Embodiment 3

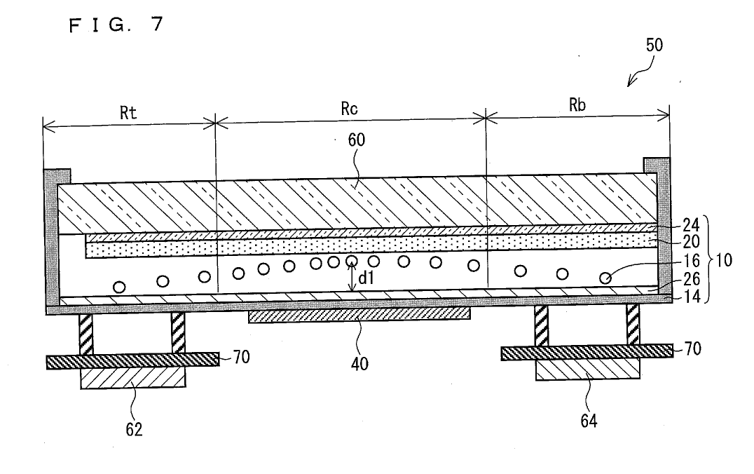

The following describes another embodiment of the present invention with reference to FIG. 7. Note that structures other than what is described in the present embodiment are the same as that of Embodiment 1. Further, for convenience in description, identical reference signs are provided to members having identical functions with members indicated in the drawings of Embodiment 1, and descriptions of such members are omitted here.

A backlight module 10 of the present embodiment is different from the backlight module 10 of Embodiment 1 in that height (shortest distance d1 from the lamps 16 to the backlight chassis 14) of the lamps 16 is uneven.

The following describes the backlight module 10 with reference to FIG. 7 which is a drawing showing a cross-section of a liquid crystal backlight unit 50 of the present embodiment (Embodiment 3). Note that FIG. 7 is a view corresponding to a cross-section taken along line A-A of FIG. 2.

As shown in FIG. 7, the backlight module 10 of the present embodiment, as with the backlight chassis 14 of Embodiment 1, has a backlight chassis 14 whose bottom is flat, however, the shortest distance d1 from the lamps 16 to the backlight chassis 14 is not even in the backlight module

That is, the shortest distance d1 from the lamps 16 to the backlight chassis 14 increases substantially symmetrically from the end parts of the backlight chassis 14 to the center part of the backlight chassis 14. In other words, the lamps 16 are arranged so as to form a mountain shape.

Accordingly, in a center area Rc where the lamps 16 are closely spaced and gaps P between adjacent lamps 16 are narrow, the shortest distance d1 is long. This makes it difficult for heat generated from the lamps 16 to be conducted to the backlight chassis 14. As a result, a temperature rise in the center area Rc is prevented, in which area the lamps 16 are arranged with high density and its temperature is likely to increase.

Further, in the center area Rc, the gaps between the liquid crystal panel 60 and the lamps 16 are made narrow. This allows efficient emission of light from the lamps 16. Thus, in the center area Rc which requires brightness, in order to secure the brightness, it is possible to avoid increasing the number of lamps 16, as compared to the other areas (upper area Rt and lower area Rb). Hence, since the number of the lamps 16 in the center area Rc is reduced, it is possible to prevent the temperature of the backlight chassis 14 from rising.

### Embodiment 4

The following describes another embodiment of the present invention with reference to drawings. Note that a structure other than what is described in the present embodiment is identical to Embodiment 1. Further, for convenience in description, identical reference signs are provided to members having identical functions as the members indicated in drawings of the Embodiment 1, and descriptions of the members are omitted here.

A backlight module 10 of the present embodiment is different from the backlight module 10 of Embodiment 1 in its position of a heat generating substrate.

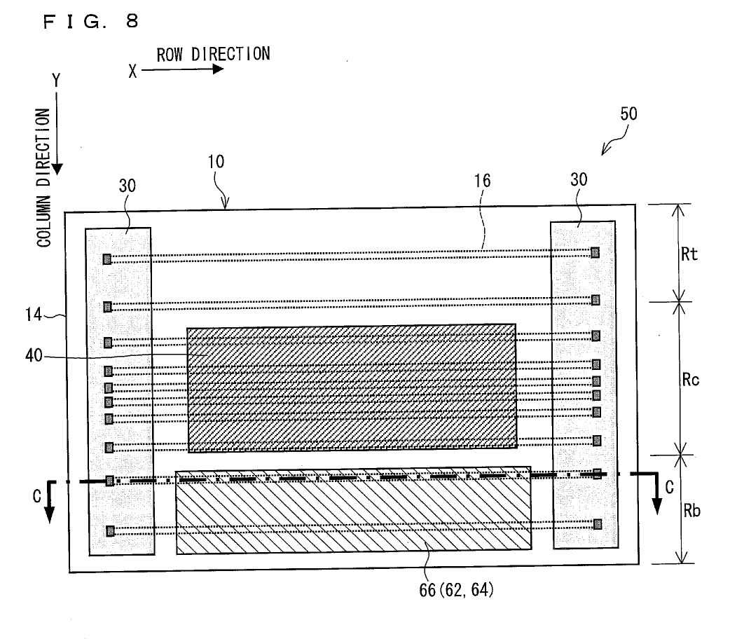

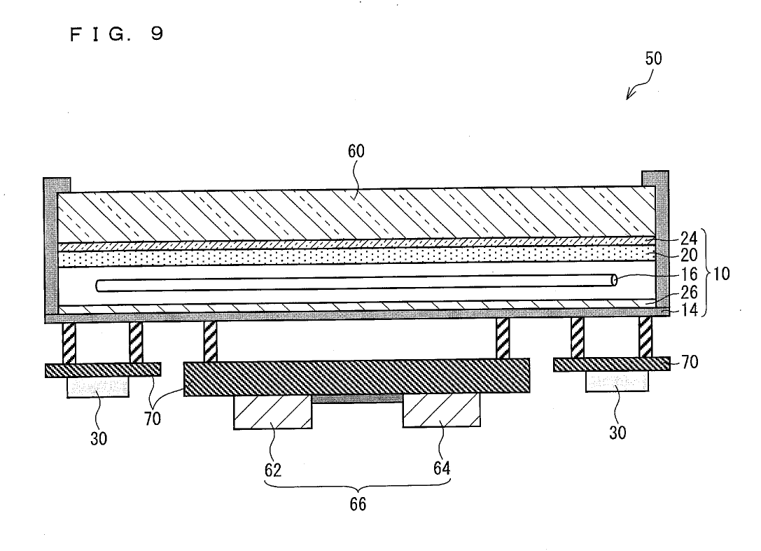

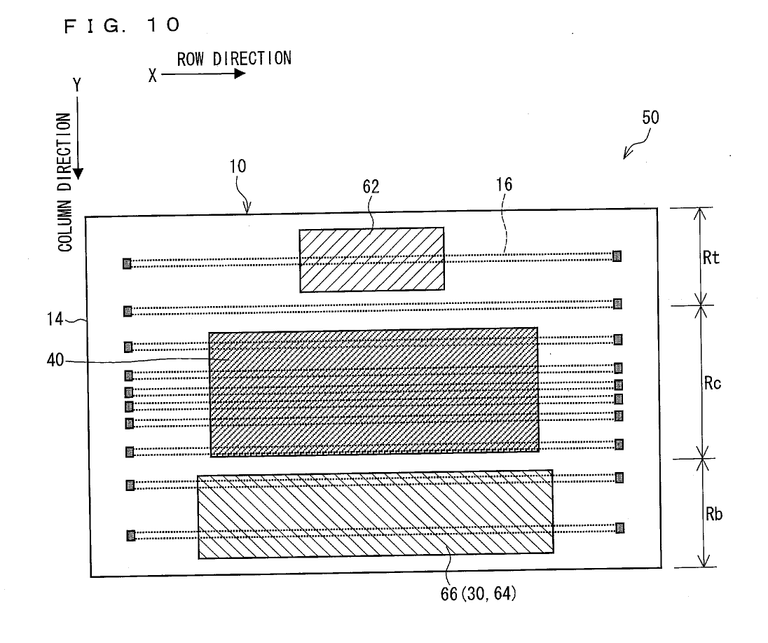

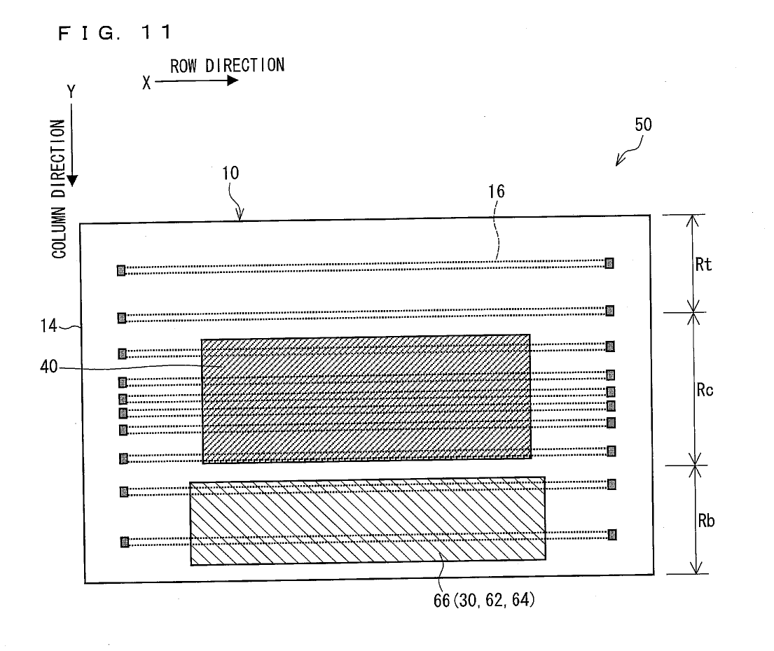

The following description explains a liquid crystal backlight unit 50 of the present embodiment (Embodiment 4) with respect to FIG. 8, FIG. 10 and FIG. 11, each of which is a plan view of a backside of the liquid crystal backlight unit 50, and FIG. 9 which is a cross-sectional view taken along line C-C of FIG. 8.

First, the following describes the liquid crystal backlight unit 50 shown in FIG. 8 and FIG. 9.

In the liquid crystal backlight unit 50 of Embodiment 1, the substrates which are capable of generating heat (heat generating substrates) are positioned in such a manner that the substrates surround the heat releasing member 40 on all its four sides.

However, in the present embodiment, as shown in FIG. 8, from a backside view of the backlight chassis 14, although the inverter substrates 30 are respectively arranged in right and left sides of the heat releasing member 40 as with Embodiment 1, a heat generating substrate is not arranged in an upper side of the heat releasing member 40, which is what differs from the Embodiment 1.

In Embodiment 1, the main substrate 62 and the power supply substrate 64 are arranged separately; the main substrate 62 is arranged lower of the heat releasing member 40, and the power supply substrate 64 is arranged upper of the heat releasing member 40. However, in the present embodiment, both the main substrate 62 and the power supply substrate 64 are arranged on one substrate, and this substrate is provided lower of the heat releasing member 40.

Therefore, since a heat generating substrate is not upper of the heat releasing member 40, and the heat generating substrate is arranged only in the lower part of the heat releasing member 40, the heat releasing member 40 effectively releases heat of the heat generating substrate and heat of the liquid crystal backlight unit 50.

The following describes a sectional structure of the liquid crystal backlight unit 50 with reference to FIG. 9, which is a view showing a cross-section taken along line C-C of FIG. 8.

As shown in FIG. 9, a composite substrate 66 which integrates the main substrate 62 and the power supply substrate 64 is provided to the backlight chassis 14 via a seat 70.

Note that an identical seat to one described in the foregoing embodiment may be used as the seat 70.

Further, in the present embodiment, the composite substrate 66 is provided on one seat 70. That is, two substrates are substantially provided on the one seat 70. Since it is predictable that the amount of heat increases, a thickness of a flat part of the seat 70 may be increased in thickness and/or a height of the seat 70 may be raised.

Furthermore, examples of other arrangements of the heat generating substrate include arrangements shown in FIG. 10 and FIG. 11.

That is to say, in the arrangement shown in FIG. 10, the heat generating substrates such as the inverter substrates 30 are not positioned right and left of the heat releasing member 40, and the heat generating substrates are positioned only upper and lower of the heat releasing member 40.

Specifically, the main substrate 62 is positioned upper of the heat releasing member 40 as with Embodiment 1, and the composite substrate 66 is positioned lower of the heat releasing member 40. Further, the composite substrate includes an inverter substrate 30 and a power supply substrate 64.

With this structure, the heat generating substrates (inverter substrates 30) positioned right and left of the heat releasing member 40 in Embodiment 1 are positioned lower of the heat releasing member 40, as one part of the composite substrate 66. This attains a higher heat releasing effect by the heat releasing member 40 than a case in which the heat generating substrates are positioned right and left of the heat releasing member 40.

Thus, it is possible to effectively prevent the backlight module 10 from rising in temperature.

Moreover, an example of another positioning of the heat generating substrate includes an arrangement shown in FIG. 11.

That is to say, in the arrangement, the heat generating substrate is positioned only lower of the heat releasing member 40.

Specifically, a composite substrate 66 is positioned lower of the heat releasing member 40, and this composite substrate 66 includes all of the heat generating substrates such as the inverter substrates 30, the main substrate 62, and the power supply substrate 64.

With this structure, since all heat generating substrates are positioned lower of the heat releasing member 40, heat from the heat generating substrates is released effectively, thereby effectively preventing the backlight module 10 from rising in temperature.

Television Set

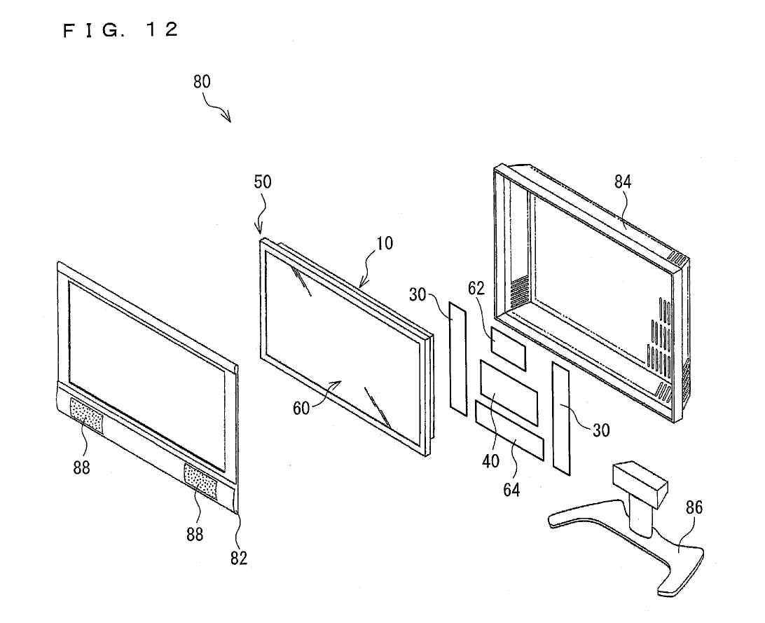

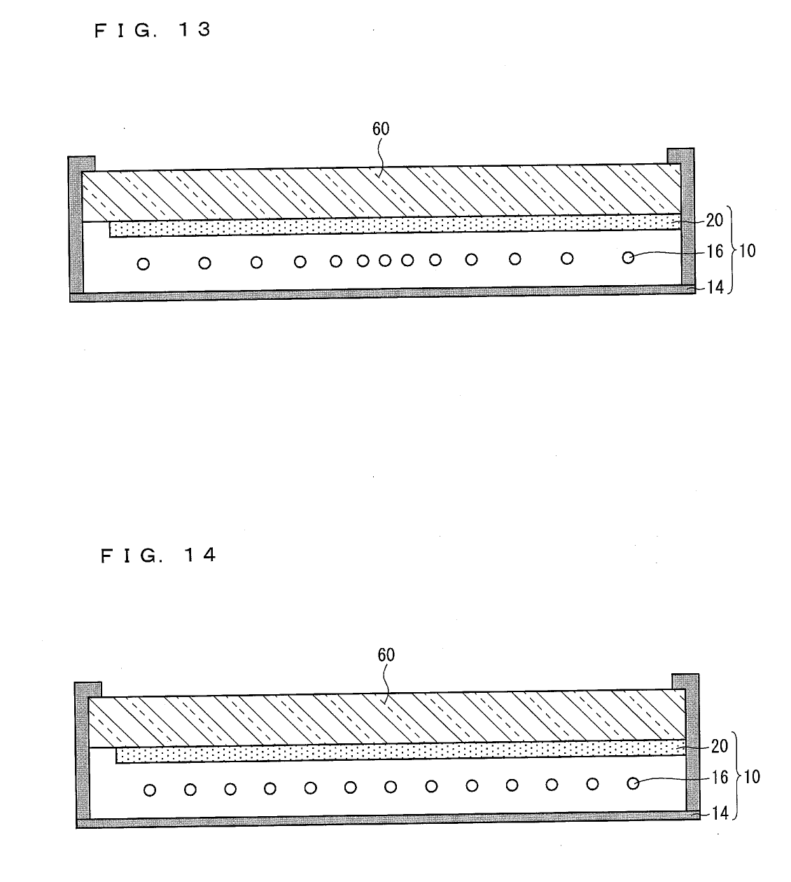

The following schematically describes an example of a structure of a television set 80 that includes a backlight module 10 of the present invention, with respect to FIG. 12. Here, FIG. 12 is a perspective view schematically showing the structure of the television set 80 of the present invention.

As shown in FIG. 12, the television set 80 includes the liquid crystal backlight unit 50 already described, and the liquid crystal backlight unit 50 is sandwiched between a front housing 82 and a back housing 84.

Further, the liquid crystal backlight unit 50 includes the backlight module 10 and a liquid crystal panel 60.

Furthermore, as shown in FIG. 12, the backlight module 10 includes the inverter substrates 30, main substrate 62, power supply substrate 64 and heat releasing member 40.

The front housing 82 and the back housing 84 sandwich, in addition to the liquid crystal backlight unit 50, various components that are requisite for the television set to function as a receiving device. Examples thereof include a television tuner circuit board (tuner section; not shown), a power supply circuit board (not shown), and a control circuit board (not shown). Moreover, the front housing 82 includes speakers 88.

In addition, the television set 80 includes a housing stand 86 for setting the television set 80.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The foregoing description describes a sheet-form heat releasing member 40, however, the member is not limited to this. For example, the heat releasing member 40 may be not a heat releasing sheet but a heat releasing plate, and the heat releasing plate may be on the backlight chassis 14 via an adhesive agent.

Further, the foregoing describes a structure in case of a waved backside of the backlight chassis 14, in which the sheet-form heat releasing member 40 having an even thickness is attached to a waved surface of the backlight chassis 14 (see FIG. 5). However, a shape of the heat releasing member 40 is not limited to this. For example, the heat releasing member 40 may be attached to depressed parts, that is, dipped parts of the wave.

Thus, the heat releasing member 40 is provided on the backside of the backlight chassis 14 while avoiding an increase in thickness of the backlight module 10.

Further, the waved shape is not limited to a sine-waved shape of a curved line, and may be, for example, a serrate shape in such a manner that a plurality of triangles is combined.

Furthermore, the foregoing describes a structure in which the lamps 16 arranged in high density are provided in a center area Rc of the backlight module 10. However, the structure is not limited to this. It is possible to arrange the lamps 16 in high density for example at other areas or directions, in accordance with a desired display characteristic.

### INDUSTRIAL APPLICABILITY

Since the present invention prevents rising in temperature of a backlight module, the present invention is suitably applicable for a large-sized television set.

1. A backlight module, comprising:
a backlight chassis; and
a plurality of light sources arranged in the backlight chassis,
the light sources being arranged in an area of the backlight chassis in which the light sources are to be positioned, so that a main longitudinal direction of the light sources lies in a first direction and the light sources are arranged at uneven intervals, the area having a high-density area in which the light sources are arranged with high density and a low-density area in which the light sources are arranged with low density,
the backlight chassis having a heat releasing member arranged on its backside in the high-density area.

2. The backlight module as set forth in claim 1, wherein:
the high-density area is provided at a middle part in a direction intersecting with the first direction of the area in which the light sources are arranged.

3. The backlight module as set forth in claim 1, wherein:
the heat releasing member is made of at least one of copper, silicone, aluminum and ceramics.

4. The backlight module as set forth in claim 1, wherein:
the backside of the backlight chassis of the high-density area is made in a waved form.

5. The backlight module as set forth in claim 4, wherein:
the intervals between the light sources in the high-density area match intervals of the waves.

6. The backlight module as set forth in claim 1, wherein:
the heat releasing member is provided as a sheet-form, and is attached to the backside of the backlight chassis with an adhesive agent, to arrange the heat releasing member on the backside of the backlight chassis.

7. A liquid crystal backlight unit, comprising:
a backlight module as set forth in claim 1; and
a liquid crystal panel incorporated in the backlight module,
the first direction being a horizontal direction when seen from viewers of the liquid crystal panel.

8. The liquid crystal backlight unit as set forth in claim 7, further comprising:
a circuit board for controlling the light sources or the liquid crystal panel, arranged on the backside of the backlight chassis in an area other than an area upper of the heat releasing member.

9. The liquid crystal backlight unit as set forth in claim 8, wherein:
the circuit board is arranged on the backside of the backlight chassis just in an area lower of the heat releasing member.

10. A television set, comprising:
a liquid crystal backlight unit as set forth in claim 7.
